(19) United States
(12) Patent Application Publication
(10) Pub. No.: US 2003/0133130 A1
(43) Pub. Date: Jul. 17, 2003

(54) Three-dimensional information acquiring system for acquiring three-dimensional shape and surface attributes of object

(75) Inventor: Kazuhiko Takahashi, Hachioji-shi (JP)

Correspondence Address: SCULLY SCOTT MURPHY & PRESSER, PC, 400 GARDEN CITY PLAZA, GARDEN CITY, NY, 11530

(73) Assignee: OLYMPUS OPTICAL CO., LTD., TOKYO (JP)

(21) Appl. No.: 10/341,006

(22) Filed: Jan. 13, 2003

(30) Foreign Application Priority Data
Jan. 16, 2002 (JP) 2002-007689

(51) Int. Cl. G01B 11/24

(52) U.S. Cl. 356/603

(57) ABSTRACT

An image photographing section acquires a pattern projection image, and a normally photographed image without pattern for an object. A three-dimensional information acquiring section acquires a three-dimensional shape and surface attributes of the object based on the pattern projection image and the normally photographed image. The three-dimensional information acquiring section has a positional offset calculating section, a correction calculation processing executing section, and a three-dimensional shape and surface attribute acquisition calculating section which acquires the three-dimensional shape and the surface attributes of the object by utilizing results of the correction calculation processing by the correction calculation processing executing section and the pattern projection image or the normally photographed image on which the correction calculation processing has not been carried out.

### CROSS-REFERENCE TO RELATED APPLICATIONS

This application is based upon and claims the benefit of priority from the prior Japanese Patent Application No. 2002-007689, filed Jan. 16, 2002, the entire contents of which are incorporated herein by reference.

### BACKGROUND OF THE INVENTION

1. Field of the Invention

The present invention relates to a three-dimensional information acquiring system including a three-dimensional information acquiring device and a three-dimensional information acquiring method, and in particular, to a three-dimensional information acquiring system including a three-dimensional information acquiring device and a three-dimensional information acquiring method in which the accuracy of pasting shape information and surface attributes of an object whose three-dimensional information is acquired can be improved.

2. Description of the Related Art

Conventionally, as a method of acquiring, without contact, three-dimensional information of an object, a three-dimensional information acquiring method by stereo measurement has been known.

The three-dimensional information acquiring method by stereo measurement obtains an image of the object from different standpoints, and acquires three-dimensional information of the object from the positional relationships of the respective standpoints and the differences in the ways the respective images can be viewed.

For example, as shown in FIG. 16, a plurality of images 2 from a plurality of (in this case, two) standpoints are obtained, and one image among them is used as a reference image 3 (in this case, the image illustrated at the left side).

Then, the distances up to points A and B are calculated based on the differences (hereinafter, parallax) between positions A1 and B1 on the coordinate of the reference image 3 and positions A2 and B2 on the coordinate of the image 2 of the points A and B on an object 4, and based on the principles of trigonometrical survey from the positions of the standpoints and the directions of the standpoints.

Generally, when acquisition of three-dimensional information by stereo images is carried out, the corresponding relationship between points on a reference image and points on another image is recognized by corresponding point searching.

As such a method of recognizing the corresponding relationship between points on the reference image and points on the other image by corresponding point searching, for example, the method which is explained in Jpn. Pat. Appln. KOKAI Publication No. 6-215111, and the like are known.

However, when the corresponding point searching is carried out, in the case where the surface of the object has few features (smooth surfaces, walls, or the like) or is configured of a repeating pattern, corresponding point searching is difficult by only normal stereo photographing, and it leads to an increase of mistakes in correspondence.

As shown in Jpn. Pat. Appln. KOKOKU Publication No. 4-25758, there is a method in which photographing, in which the surface of the objective is optically made to have features, is carried out by carrying out pattern projection, and the shape of the object is recognized by carrying out corresponding point searching, and separately, the surface attributes of the object are acquired by normally photographing.

Further, as another method of acquiring shape information, even if a plurality of image pick-up systems are not used, as described in Jpn. Pat. Appln. KOKAI Publication No. 2000-292121, there is a method in which known patterned light (containing slit light) is projected on an object and shape recognition is carried out by photographing a deformed state of the pattern, and separately, three-dimensional information of the object is acquired by acquiring the surface attributes of the object by normally photographing.

In this case as well, the surface attributes of the object are obtained separately by normally photographing.

In the prior art described above, the surface attributes of the object are acquired from an image obtained by normal photographing, and the shape information of the object is acquired from pattern projection photographing.

However, in this case, normal photographing and pattern projection photographing cannot be simultaneously carried out, and there is a difference in the times when the respective images are obtained.

Namely, because there is a difference in time between the time of pattern projection photographing and the time of normal photographing, cases arise in which the object position in a pattern projection image which is an image for acquiring a three-dimensional shape is different from the object position in a normally photographed image which is an image for acquiring surface attributes of the object such as texture (color information) or the like, due to blurring caused by the hands or movement of the object.

Accordingly, if this method is used as is, it is problematic with regard to the point that a correct reconstruction of a three-dimensional image cannot be carried out.

Such a problem caused by a difference in times is overcome to some extent by continuously and speedily carrying out the two photographings. However, effects such as slight movement of the object, blurring caused by the hands of the photographer, or the like cannot be eliminated.

### BRIEF SUMMARY OF THE INVENTION

An object of the present invention has been achieved in consideration of the above-described circumstances, and is to provide a three-dimensional information acquiring system including a three-dimensional information acquiring device and a three-dimensional information acquiring method in which positional offset of an object in a pattern projection image and a normally photographed image is detected and corrected, and by acquiring three-dimensional information, the accuracy of pasting the shape information and the surface attributes of the object can be improved, and correct reconstruction of a three-dimensional image can be carried out.

(Definitions of Terms)

“Stereo photographing” in the present specification means photographing from a plurality of standpoints.

Moreover, “stereo photographing” in the present specification includes a case in which an image from a plurality of standpoints is obtained by one photographing device by using a stereo converter or the like, and a case of using a plurality of photographing devices.

In addition, “an image obtained by stereo photographing” means an image from a plurality of standpoints.

In this case, not only a plurality of images from a plurality of photographing devices, but also one image into which images from a plurality of standpoints are buried, are included.

In order to achieve the above object, according to a first aspect of the present invention, there is provided a three-dimensional information acquiring device which obtains a pattern projection image, in which an object is photographed with projecting a predetermined pattern on the object, and a normally photographed image, in which the object is photographed without projecting the pattern before or after the photographing of the pattern projection image, and which acquires a three-dimensional shape and surface attributes of the object based on the pattern projection image and the normally photographed image, the three-dimensional information acquiring device comprising:

a positional offset calculating section which calculates offset between a position of the object in the pattern projection image and a position of the object in the normally photographed image;

a correction calculation processing executing section which executes correction calculation processing on the pattern projection image or the normally photographed image so as to eliminate the offset between the positions of the object calculated by the positional offset calculating section; and

a three-dimensional shape and surface attribute acquisition calculating section which acquires the three-dimensional shape and the surface attributes of the object by utilizing results of the correction calculation processing by the correction calculation processing executing section and the pattern projection image or the normally photographed image on which the correction calculation processing has not been carried out.

(Operation)

The three-dimensional information acquiring device obtains a pattern projection image (8, 16), in which the object is photographed with projecting a predetermined pattern on the object, and a normally photographed image (10, 17), in which the object is photographed without projecting the pattern before or after the photographing of the pattern projection image, and acquires the three-dimensional shape and surface attributes of the object based on the pattern projection image and the normally photographed image.

At this time, the three-dimensional information acquiring device has a positional offset calculating section 121, a correction calculation processing executing section 122, and a three-dimensional shape and surface attribute acquisition calculating section 123 which are shown as functional blocks in a calculation device 12 such as, for example, a personal computer.

First, the positional offset calculating section 121 of the calculation device 12 calculates the offset between the position of the object in the pattern projection image and the position of the object in the normally photographed image.

The correction calculation processing executing section 122 of the calculation device 12 executes correction calculation processing on the pattern projection image or the normally photographed image so as to eliminate the calculated offset.

Further, the three-dimensional shape and surface attribute acquisition calculating section 123 of the calculation device 12 acquires the three-dimensional shape and the surface attributes of the object by utilizing the results of the correction calculation processing and the pattern projection image or the normally photographed image on which the correction calculation processing has not been carried out.

Then, the three-dimensional shape and surface attribute acquisition calculating section 123 of the calculation device 12 pastes the surface attributes on the surface shape and outputs the three-dimensional information of the object 4. Accordingly, the offset between the normally photographed image obtained by normal photographing and the pattern projection image obtained by projecting patterned light is corrected, so that it is possible to paste the surface attributes on the acquired three-dimensional shape information without offset.

In order to achieve the above object, according to a second aspect of the present invention, there is provided a three-dimensional information acquiring device according to the first aspect, wherein, when the positional offset calculating section calculates the offset between the position of the object in the pattern projection image and the position of the object in the normally photographed image, the positional offset calculating section sets offset searching points on one image of the pattern projection image and the normally photographed image and searches for corresponding points on the other image which correspond to the offset searching points, and specifies positions of the corresponding points and calculates the offset of the object based on differences between the offset searching points and the corresponding points.

(Operation)

When the offset between the position of the object in the pattern projection image and the position of the object in the normally photographed image is to be calculated, the positional offset calculating section 121 sets offset searching points on one image of the pattern projection image and the normally photographed image, and searches for corresponding points on the other image which correspond to the offset searching points, and specifies the positions of the corresponding points, and calculates the offset of the object based on the positional differences between the searching points and the corresponding points. Accordingly, the offset between the normally photographed image obtained by normal photographing and the pattern projection image obtained by projecting patterned light is corrected, so that it is possible to paste the surface attributes on the acquired three-dimensional shape information without offset.

In order to achieve the above object, according to a third aspect of the present invention, there is provided a three-dimensional information acquiring device according to the second aspect, wherein, when the positional offset calculating section sets the offset searching points on one image of the pattern projection image and the normally photographed image, the positional offset calculating section sets a plurality of points, which are set in a specific region of a part of the pattern projection image or the normally photographed image, as the offset searching points.

(Operation)

When the offset searching points are to be set on one image of the pattern projection image and the normally photographed image, the positional offset calculating section 121 sets, as the offset searching points, a plurality of points which are set in a specific region of a part of the pattern projection image or the normally photographed image.

In order to achieve the above object, according to a fourth aspect of the present invention, there is provided a three-dimensional information acquiring device according to the third aspect, wherein, when the positional offset calculating section sets the offset searching points on one image of the pattern projection image and the normally photographed image, the positional offset calculating section sets a plurality of points, which are set based on features of the pattern projection image or the normally photographed image, as the offset searching points.

(Operation)

When the offset searching points are to be set on one image of the pattern projection image and the normally photographed image, the positional offset calculating section 121 sets, as the offset searching points, a plurality of points which are set based on features of the pattern projection image or the normally photographed image.

In order to achieve the above object, according to a fifth aspect of the present invention, there is provided a three-dimensional information acquiring device according to the third aspect, wherein, when the positional offset calculating section sets the offset searching points on one image of the pattern projection image and the normally photographed image, the positional offset calculating section sets a plurality of points, which are selected by an operator on the pattern projection image or the normally photographed image, as the offset searching points.

(Operation)

When the offset searching points are to be set on one image of the pattern projection image and the normally photographed image, the positional offset calculating section 121 sets, as the offset searching points, a plurality of points selected by an operator in the pattern projection image or the normally photographed image.

In order to achieve the above object, according to a sixth aspect of the present invention, there is provided a three-dimensional information acquiring system for acquiring a three-dimensional shape and surface attributes of an object, comprising:

an image photographing section which obtains a pattern projection image, in which the object is photographed with projecting a predetermined pattern on the object, and obtains a normally photographed image, in which the object is photographed without projecting the pattern before or after the obtaining of the pattern projection image; and

a three-dimensional information acquiring section which acquires the three-dimensional shape and the surface attributes of the object based on the pattern projection image and the normally photographed image obtained by the image photographing section, the three-dimensional information acquiring section comprising:

a positional offset calculating section which calculates offset between a position of the object in the pattern projection image and a position of the object in the normally photographed image;

a correction calculation processing executing section which executes correction calculation processing on the pattern projection image or the normally photographed image so as to eliminate the offset between the positions of the object calculated by the positional offset calculating section; and

a three-dimensional shape and surface attribute acquisition calculating section which acquires the three-dimensional shape and the surface attributes of the object by utilizing results of the correction calculation processing by the correction calculation processing executing section and the pattern projection image or the normally photographed image on which the correction calculation processing has not been carried out.

In order to achieve the above object, according to a seventh aspect of the present invention, there is provided a three-dimensional information acquiring system according to the sixth aspect, wherein, when the positional offset calculating section calculates the offset between the position of the object in the pattern projection image and the position of the object in the normally photographed image, the positional offset calculating section sets offset searching points on one image of the pattern projection image and the normally photographed image and searches for corresponding points on the other image which correspond to the offset searching points, and specifies positions of the corresponding points and calculates the offset of the object based on differences between the offset searching points and the corresponding points.

In order to achieve the above object, according to an eighth aspect of the present invention, there is provided a three-dimensional information acquiring system according to the seventh aspect, wherein, when the positional offset calculating section sets the offset searching points on one image of the pattern projection image and the normally photographed image, the positional offset calculating section sets a plurality of points, which are set in a specific region of a part of the pattern projection image or the normally photographed image, as the offset searching points.

In order to achieve the above object, according to a ninth aspect of the present invention, there is provided a three-dimensional information acquiring system according to the eighth aspect, wherein, when the positional offset calculating section sets the offset searching points on one image of the pattern projection image and the normally photographed image, the positional offset calculating section sets a plurality of points, which are set based on features of the pattern projection image or the normally photographed image, as the offset searching points.

In order to achieve the above object, according to a tenth aspect of the present invention, there is provided a three-dimensional information acquiring system according to the eighth aspect, wherein, when the positional offset calculating section sets the offset searching points on one image of the pattern projection image and the normally photographed image, the positional offset calculating section sets a plurality of points, which are selected by an operator on the pattern projection image or the normally photographed image, as the offset searching points.

In order to achieve the above object, according to an eleventh aspect of the present invention, there is provided a three-dimensional information acquiring method for obtaining a pattern projection image, in which an object is photographed with projecting a predetermined pattern on the object, and a normally photographed image, in which the object is photographed without projecting the pattern before or after the photographing of the pattern projection image, and for acquiring a three-dimensional shape and surface attributes of the object based on the pattern projection image and the normally photographed image, the three-dimensional information acquiring method comprising:

calculating offset between a position of the object in the pattern projection image and a position of the object in the normally photographed image;

executing correction calculation processing on the pattern projection image or the normally photographed image so as to eliminate the offset between the calculated positions of the object; and

acquiring the three-dimensional shape and the surface attributes of the object by utilizing the results of the correction calculation processing and the pattern projection image or the normally photographed image on which the correction calculation processing has not been carried out.

(Operations)

The three-dimensional information acquiring method obtains a pattern projection image (8, 16), in which an object is photographed with projecting a predetermined pattern on the object, and the normally photographed image (10, 17), in which the object is photographed without projecting the pattern, and acquires the three-dimensional shape and surface attributes of the object based on the pattern projection image and the normally photographed image.

At this time, the offset between a position of the object in the pattern projection image and a position of the object in the normally photographed image is calculated.

Further, correction calculation processing is executed on the pattern projection image or the normally photographed image so as to eliminate the calculated offset.

In addition, the three-dimensional shape and the surface attributes of the object are acquired by utilizing the results of the correction calculation processing and the pattern projection image or the normally photographed image on which the correction calculation processing has not been carried out.

Then, by pasting the surface attributes on the surface shape and outputting the three-dimensional information of the object 4, the offset between the normally photographed image obtained by normal photographing and the pattern projection image obtained by projecting patterned light is corrected, so that the surface attributes can be pasted on the acquired three-dimensional shape information without offset.

In order to achieve the above object, according to a twelfth aspect of the present invention, there is provided a three-dimensional information acquiring method according to the eleventh aspect, wherein, when offset between the position of the object in the pattern projection image and the position of the object in the normally photographed image is calculated, offset searching points are set on one image of the pattern projection image and the normally photographed image, and corresponding points on the other image which correspond to the offset searching points are searched for, and positions of the corresponding points are specified, and the offset of the object is calculated based on differences between the offset searching points and the corresponding points.

(Operation)

When offset between the position of the object in the pattern projection image and the position of the object in the normally photographed image is calculated, offset searching points are set on one image of the pattern projection image and the normally photographed image, and the corresponding points on the other image which correspond to the offset searching points are searched for, and the positions of the corresponding points are specified, and the offset of the object is calculated based on the differences between the searching points and the corresponding points. Accordingly, the offset between the normally photographed image obtained by normal photographing and the pattern projection image obtained by projecting patterned light is corrected, so that the surface attributes can be pasted on the acquired three-dimensional shape information without offset.

In order to achieve the above object, according to a thirteenth aspect of the present invention, there is provided a three-dimensional information acquiring method according to the twelfth aspect, wherein, when the offset searching points are set on one image of the pattern projection image and the normally photographed image, a plurality of points, which are set in a specific region of a part of the pattern projection image or the normally photographed image, are set as the offset searching points.

(Operation)

When the offset searching points are set to be on one image of the pattern projection image and the normally photographed image, a plurality of points, which are set in a specific region of a part of the pattern projection image or the normally photographed image, are set as the offset searching points.

In order to achieve the above object, according to a fourteenth aspect of the present invention, there is provided a three-dimensional information acquiring method according to the thirteenth aspect, wherein, when the offset searching points are set on one image of the pattern projection image and the normally photographed image, a plurality of points, which are set based on features of the pattern projection image or the normally photographed image, are set as the offset searching points.

(Operation)

When the offset searching points are to be set on one image of the pattern projection image and the normally photographed image, a plurality of points, which are set based on features of the pattern projection image or the normally photographed image, are set as the offset searching points.

In order to achieve the above object, according to a fifteenth aspect of the present invention, there is provided a three-dimensional information acquiring method according to the thirteenth aspect, wherein, when the offset searching points are set on one image of the pattern projection image and the normally photographed image, a plurality of points, which are selected by an operator on the pattern projection image or the normally photographed image, are set as the offset searching points.

(Operation)

When the offset searching points are to be set on one image of the pattern projection image and the normally photographed image, a plurality of points, which are selected by an operator in the pattern projection image or the normally photographed image, are set as the offset searching points.

In order to achieve the above object, according to a sixteenth aspect of the present invention, there is provided a three-dimensional information acquiring device for obtaining a pattern projection image, in which an object is photographed with projecting a predetermined pattern on the object, and a normally photographed image, in which the object is photographed without projecting the pattern before or after the photographing of the pattern projection image, and for acquiring three-dimensional shape and surface attributes of the object based on the pattern projection image and the normally photographed image, the three-dimensional information acquiring device comprising:

positional offset calculating means for calculating offset between a position of the object in the pattern projection image and a position of the object in the normally photographed image;

correction calculation processing executing means for executing correction calculation processing on the pattern projection image or the normally photographed image so as to eliminate the offset between the positions of the object calculated by the positional offset calculating means; and

three-dimensional shape and surface attribute acquisition calculating means for acquiring the three-dimensional shape and the surface attributes of the object by utilizing results of the correction calculation processing by the correction calculation processing executing means and the pattern projection image or the normally photographed image on which the correction calculation processing has not been carried out.

In order to achieve the above object, according to a seventeenth aspect of the present invention, there is provided a three-dimensional information acquiring device according to the sixteenth aspect, wherein, when the positional offset calculating means calculates the offset between the position of the object in the pattern projection image and the position of the object in the normally photographed image, the positional offset calculating means sets offset searching points on one image of the pattern projection image and the normally photographed image and searches for corresponding points on the other image which correspond to the offset searching points, and specifies positions of the corresponding points and calculates the offset of the object based on differences between the offset searching points and the corresponding points.

In order to achieve the above object, according to an eighteenth aspect of the present invention, there is provided a three-dimensional information acquiring device according to the seventeenth aspect, wherein, when the positional offset calculating means sets the offset searching points on one image of the pattern projection image and the normally photographed image, the positional offset calculating means sets a plurality of points, which are set in a specific region of a part of the pattern projection image or the normally photographed image, as the offset searching points.

In order to achieve the above object, according to a nineteenth aspect of the present invention, there is provided a three-dimensional information acquiring device according to the eighteenth aspect, wherein, when the positional offset calculating means sets the offset searching points on one image of the pattern projection image and the normally photographed image, the positional offset calculating means sets a plurality of points, which are set based on features of the pattern projection image or the normally photographed image, as the offset searching points.

In order to achieve the above object, according to a twentieth aspect of the present invention, there is provided a three-dimensional information acquiring device according to the eighteenth aspect, wherein, when the positional offset calculating means sets the offset searching points on one image of the pattern projection image and the normally photographed image, the positional offset calculating means sets a plurality of points, which are selected by an operator on the pattern projection image or the normally photographed image, as the offset searching points.

In order to achieve the above object, according to a twenty-first aspect of the present invention, there is provided a three-dimensional information acquiring system for acquiring a three-dimensional shape and surface attributes of an object, comprising:

image photographing means for obtaining a pattern projection image, in which an object is photographed with projecting a predetermined pattern on the object, and for obtaining a normally photographed image, in which the object is photographed without projecting the pattern before or after the obtaining of the pattern projection image; and

three-dimensional information acquiring means for acquiring the three-dimensional shape and the surface attributes of the object based on the pattern projection image and the normally photographed image obtained by the image photographing means, the three-dimensional information acquiring means comprising:

positional offset calculating means for calculating offset between a position of the object in the pattern projection image and a position of the object in the normally photographed image;

correction calculation processing executing means for executing correction calculation processing on the pattern projection image or the normally photographed image so as to eliminate the offset between the positions of the object calculated by the positional offset calculating means; and

three-dimensional shape and surface attribute acquisition calculating means for acquiring the three-dimensional shape and the surface attributes of the object by utilizing results of the correction calculation processing by the correction calculation processing executing means and the pattern projection image or the normally photographed image on which the correction calculation processing has not been carried out.

In order to achieve the above object, according to a twenty-second aspect of the present invention, there is provided a three-dimensional information acquiring system according to the twenty-first aspect, wherein, when the positional offset calculating means calculates the offset between the position of the object in the pattern projection image and the position of the object in the normally photographed image, the positional offset calculating means sets offset searching points on one image of the pattern projection image and the normally photographed image and searches for corresponding points on the other image which correspond to the offset searching points, and specifies positions of the corresponding points and calculates the offset of the object based on differences between the offset searching points and the corresponding points.

In order to achieve the above object, according to a twenty-third aspect of the present invention, there is provided a three-dimensional information acquiring system according to the twenty-second aspect, wherein, when the positional offset calculating means sets the offset searching points on one image of the pattern projection image and the normally photographed image, the positional offset calculating means sets a plurality of points, which are set in a specific region of a part of the pattern projection image or the normally photographed image, as the offset searching points.

In order to achieve the above object, according to a twenty-fourth aspect of the present invention, there is provided a three-dimensional information acquiring system according to the twenty-third aspect, wherein, when the positional offset calculating means sets the offset searching points on one image of the pattern projection image and the normally photographed image, the positional offset calculating means sets a plurality of points, which are set based on features of the pattern projection image or the normally photographed image, as the offset searching points.

In order to achieve the above object, according to a twenty-fifth aspect of the present invention, there is provided a three-dimensional information acquiring system according to the twenty-third aspect, wherein, when the positional offset calculating means sets the offset searching points are set on one image of the pattern projection image and the normally photographed image, the positional offset calculating means sets a plurality of points, which are selected by an operator on the pattern projection image or the normally photographed image, as the offset searching points.

In order to achieve the above object, according to a twenty-sixth aspect of the present invention, there is provided a three-dimensional information acquiring method for acquiring a three-dimensional shape and surface attributes of an object, comprising:

acquiring a pattern projection image, in which the object is photographed with projecting a predetermined pattern on the object, and acquiring a normally photographed image, in which the object is photographed without projecting the pattern before or after the obtaining of the pattern projection image; and

acquiring the three-dimensional shape and the surface attributes of the object based on the pattern projection image and the normally photographed image, the acquiring of the three-dimensional shape and the surface attributes of the object comprising:

calculating offset between a position of the object in the pattern projection image and a position of the object in the normally photographed image;

executing correction calculation processing on the pattern projection image or the normally photographed image so as to eliminate the offset between the positions of the object; and

acquiring the three-dimensional shape and the surface attributes of the object by utilizing results of the correction calculation processing and the pattern projection image or the normally photographed image on which the correction calculation processing has not been carried out.

In order to achieve the above object, according to a twenty-seventh aspect of the present invention, there is provided a three-dimensional information acquiring method according to the twenty-sixth aspect, wherein, when the offset between the position of the object in the pattern projection image and the position of the object in the normally photographed image is calculated, offset searching points are set on one image of the pattern projection image and the normally photographed image, and corresponding points on the other image which correspond to the offset searching points are searched for, and positions of the corresponding points are specified, and the offset of the object is calculated based on differences between the offset searching points and the corresponding points.

In order to achieve the above object, according to a twenty-eighth aspect of the present invention, there is provided a three-dimensional information acquiring method according to the twenty-seventh aspect, wherein, when the offset searching points are set on one image of the pattern projection image and the normally photographed image, a plurality of points, which are set in a specific region of a part of the pattern projection image or the normally photographed image, are set as the offset searching points.

In order to achieve the above object, according to a twenty-ninth aspect of the present invention, there is provided a three-dimensional information acquiring method according to the twenty-eighth aspect, wherein, when the offset searching points are set on one image of the pattern projection image and the normally photographed image, a plurality of points, which are set based on features of the pattern projection image or the normally photographed image, are set as the offset searching points.

In order to achieve the above object, according to a thirtieth aspect of the present invention, there is provided a three-dimensional information acquiring method according to the twenty-eighth aspect, wherein, when the offset searching points are set on one image of the pattern projection image and the normally photographed image, a plurality of points, which are selected by an operator on the pattern projection image or the normally photographed image, are set as the offset searching points.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiment of the invention, and together with the general description given above and the detailed description of the preferred embodiment given below, serve to explain the principles of the invention.

FIG. 1 is a diagram showing a configuration of a three-dimensional information acquiring device according to a first embodiment of the present invention;

FIG. 2 is a diagram showing a state in which an object is photographed by using the three-dimensional information acquiring device according to the first embodiment of the present invention;

FIGS. 3A and 3B are diagrams illustrating a normally photographed image obtained by carrying out normal photographing and a pattern projection image obtained by carrying out pattern projection photographing, when the object is photographed by using the three-dimensional information acquiring device according to the first embodiment of the present invention;

FIG. 4 is a flowchart for explanation of procedures of processing for acquiring three-dimensional information by photographing the object with the three-dimensional information acquiring device according to the first embodiment of the present invention;

FIGS. 5A and 5B are diagrams showing modified examples of a flash device for pattern projection and a flash device for normal light projection for use in the three-dimensional information acquiring device according to the first embodiment of the present invention;

FIG. 6 is a diagram which shows a configuration of a three-dimensional information acquiring device according to a second embodiment of the present invention, and which shows a state in which an object is photographed;

FIGS. 7A and 7B are a plan view and a front view showing configurations of a digital camera as a stereo image-pickup system for use in the three-dimensional information acquiring device according to the second embodiment of the present invention which is configured as shown in FIG. 6, and a stereo adapter mounted at a front surface portion of the digital camera;

FIGS. 8A and 8B are diagrams illustrating a normally photographed image obtained by carrying out normal photographing and a pattern projection image obtained by carrying out pattern projection photographing, when the object is photographed by using the three-dimensional information acquiring device according to the second embodiment of the present invention;

FIG. 9 is a diagram illustrating a case in which a plurality of offset searching points are set over the entire normally photographed image as offset searching points in the three-dimensional information acquiring device according to the second embodiment of the present invention;

FIG. 10 is a flowchart for explanation of procedures of processing for acquiring three-dimensional information by photographing the object with the three-dimensional information acquiring device according to the second embodiment of the present invention;

FIG. 11 is a diagram illustrating a case in which a plurality of offset searching points 11 are set at a central portion on a normally photographed image 17 as offset searching points in a three-dimensional information acquiring device according to a third embodiment of the present invention;

FIGS. 12A and 12B are diagrams illustrating an image in which processing of edge extraction has been carried out on the normally photographed image, and an image in which processing of edge extraction has been carried out on color components other than pattern color components which have been pattern-projected, in a three-dimensional information acquiring device according to a fourth embodiment of the present invention;

FIG. 13 is a flowchart for explaining procedures of processing for acquiring three-dimensional information by photographing an object with the three-dimensional information acquiring device according to the fourth embodiment of the present invention;

FIGS. 14A and 14B are diagrams illustrating corresponding points of a normally photographed image and corresponding points of a pattern projection image which is inputted by a user in a three-dimensional information acquiring device according to a fifth embodiment of the present invention;

FIG. 15 is a flowchart for explaining procedures of the processing for acquiring three-dimensional information by photographing an object 4 with the three-dimensional information acquiring device according to the fifth embodiment of the present invention; and

FIG. 16 is a diagram showing an example in which a plurality of images 2 from a plurality of standpoints are obtained and one of them is used as a reference image 3 in a three-dimensional information acquiring method by stereo measurement of a prior art.

### DETAILED DESCRIPTION OF THE INVENTION

Reference will now be made in detail to the presently preferred embodiments of the invention as illustrated in the accompanying drawings, in which like reference numerals designate like or corresponding parts.

Hereinafter, embodiments of the present invention will be described with reference to the drawings.

A three-dimensional information acquiring system including a three-dimensional information acquiring device and a three-dimensional information acquiring method according to the present invention is applied to a three-dimensional information acquiring system including a three-dimensional information acquiring device and a three-dimensional information acquiring method designed so as to obtain a pattern projection image, in which an object is photographed with projecting a predetermined pattern on the object, and a normally photographed image, in which the object is photographed without projecting the pattern before or after the photographing of the pattern projection image, and to acquire a three-dimensional shape and surface attributes of the object based on the pattern projection image and the normally photographed image.

(First Embodiment)

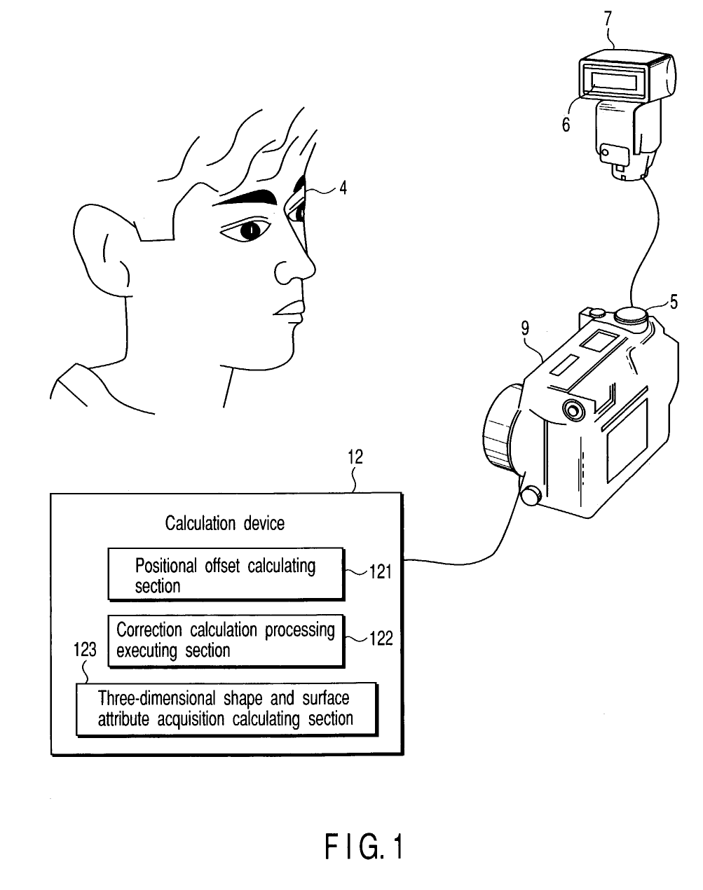

FIG. 1 is a diagram showing a configuration of the three-dimensional information acquiring device according to a first embodiment of the present invention.

Namely, as shown in FIG. 1, the three-dimensional information acquiring device according to the first embodiment of the present invention is constituted of a digital camera 5 having a built-in flash device 9 for normal photographing which will be described later, an external flash device 7 to be connected to the digital camera 5, and a calculation device 12 such as a personal computer or the like.

Here, the digital camera 5 has an electronic finder 5a serving as a display device at a back surface portion thereof.

The calculation device 12 such as a personal computer or the like has a positional offset calculating section 121, a correction calculation processing executing section 122, and a three-dimensional shape and surface attribute acquisition calculating section 123 which are shown as functional blocks in the calculation device 12.

Further, a film 6, on which a known pattern for pattern projection photographing which will be described later is printed, is loaded at a light emitting section of the external flash device 7.

In FIG. 1, a reference numeral 4 denotes an object.

The three-dimensional information acquiring device thus configured according to the first embodiment of the present invention is an example in which, in a three-dimensional information acquiring system in which pattern is projected on an object and a shape of the object is recognized from the deformation of the pattern and surface attributes of the object are acquired by normal photographing, offset between a pattern projection image and a normally photographed image is calculated by searching for offset of offset searching points which are set on the entire surface of one of the two images, and offset of the surface shape and the surface attributes is corrected by correcting the calculated offset.

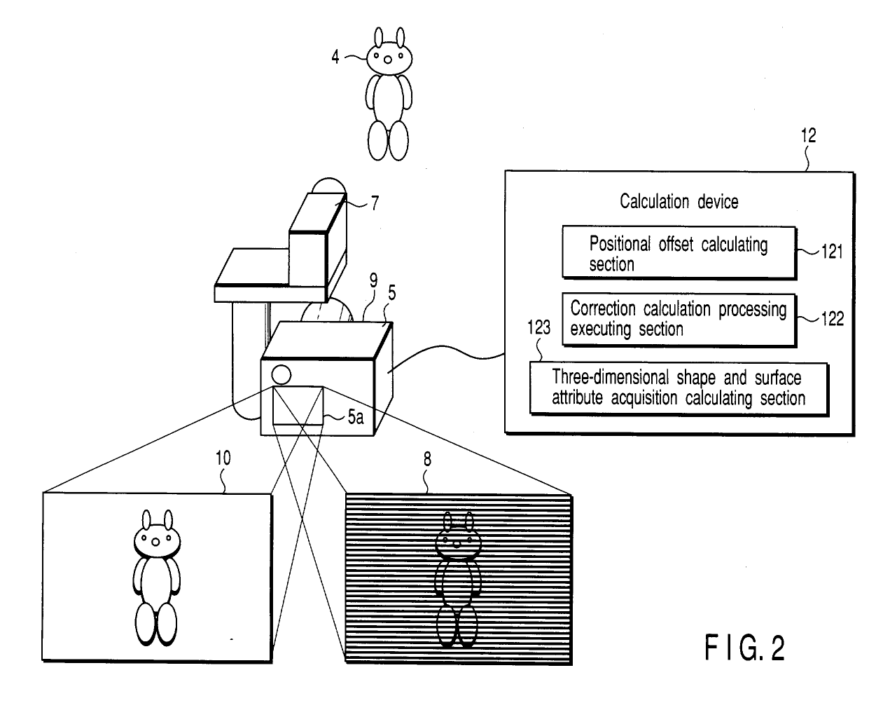

FIG. 2 is a diagram showing a state in which the object 4 is photographed by using the digital camera 5 having the built-in flash device 9, and the external flash device 7 and the calculation device 12 to be connected to the digital camera 5, as shown in FIG. 1, which constitute the three-dimensional information acquiring device according to the first embodiment of the present invention.

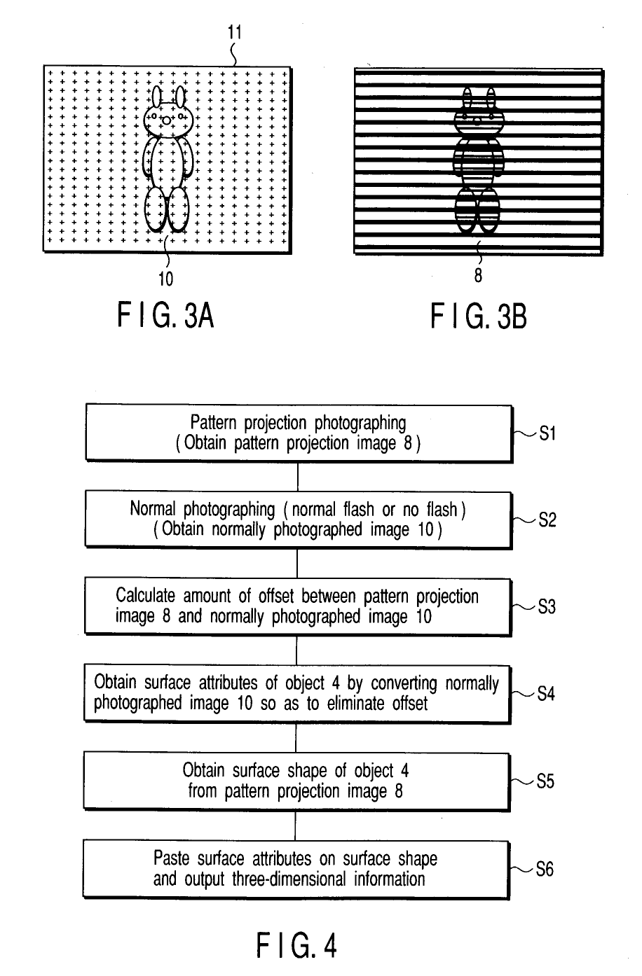

FIG. 3A is a diagram illustrating a normally photographed image 10 obtained on the electronic finder 5a provided at the digital camera 5, by normally photographing by making the built-in flash device 9 emit light when the object 4 is photographed by using the digital camera 5 having the built-in flash device 9, and the external flash device 7 and the calculation device 12 to be connected to the digital camera 5, as shown in FIG. 1, which constitute the three-dimensional information acquiring device according to the first embodiment of the present invention.

Further, FIG. 3B is a diagram illustrating a pattern projection image 8 obtained on the electronic finder 5a provided at the digital camera 5, by carrying out pattern projection photographing by making the external flash device 7 emit light when the object 4 is photographed by using the digital camera 5 having the built-in flash device 9, and the external flash device 7 and the calculation device 12 to be connected to the digital camera 5, as shown in FIG. 1, which constitute the three-dimensional information acquiring device according to the first embodiment of the present invention.

FIG. 4 is a flowchart for explaining the procedures of processing for acquiring three-dimensional information, by photographing the object 4 by use of the digital camera 5 having the built-in flash device 9, and the external flash device 7 and the calculation device 12 to be connected to the digital camera 5, as shown in FIG. 1, which constitute the three-dimensional information acquiring device according to the first embodiment of the present invention.

Next, operations of the three-dimensional information acquiring device according to the first embodiment of the present invention configured as shown in FIG. 1 will be described with reference to FIG. 2 to FIG. 4.

In other words, as shown in the flowchart of FIG. 4, in the three-dimensional information acquiring device according to the first embodiment of the present invention, first, by carrying out pattern projection photographing with respect to the object 4 by making the external flash device 7, in which the film 6 having a known pattern printed thereon is loaded at the light-emitting section, emit light by the digital camera 5, the pattern projection image 8 as shown in FIG. 3B is obtained (step S1).

Secondly, by carrying out normal photographing with respect to the object 4 by making the built-in flash device 9 emit light by the digital camera 5, the normally photographed image 10 shown in FIG. 3A is obtained (step S2).

Next, as shown in FIG. 3A, by setting a plurality of offset searching points 11 on the entire normally photographed image 10, the positional offset calculating section 121 of the calculation device 12 searches that the respective offset searching points 11 do move to which coordinates on the pattern projection image 8.

Then, the positional offset calculating section 121 of the calculation device 12 statistically processes the coordinate movements of the respective offset searching points 11, and calculates the offset between the normally photographed image 10 and the pattern projection image 8 (parallel and rotary movements) (step S3).

Subsequently, the correction calculation processing executing section 122 of the calculation device 12 converts the normally photographed image 10 in a direction in which the calculated offset is eliminated.

Further, the three-dimensional shape and surface attribute acquisition calculating section 123 of the calculation device 12 obtains, as surface attributes of the object 4, the normally photographed image 10 converted in a direction in which the calculated offset is eliminated by the correction calculation processing executing section 122 (step S4).

Next, the three-dimensional shape and surface attribute acquisition calculating section 123 of the calculation device 12 acquires a surface shape of the object 4 from information of how the known pattern is transformed and photographed on the pattern projection image 8 (step S5).

Then, the three-dimensional shape and surface attribute acquisition calculating section 123 of the calculation device 12 acquires and outputs three-dimensional information of the object 4 by pasting the surface attributes obtained in the step S4 on the surface shape obtained in the step S5 (step S6).

As described above, the calculation device 12 such as a personal computer or the like calculates the offset between the position of the object in the pattern projection image and the position of the object in the normally photographed image by the positional offset calculating section 121.

In addition, the calculation device 12 executes correction calculation processing on the pattern projection image or the normally photographed image so as to eliminate the offset calculated as described above by the correction calculation processing executing section 122.

The calculation device 12 then acquires the three-dimensional shape and the surface attributes of the object by the three-dimensional shape and surface attribute acquisition calculating section 123, by utilizing the results of the correction calculation processing and the pattern projection image or the normally photographed image on which the correction calculation processing has not been carried out.

In this way, the calculation device 12 such as a personal computer or the like functions as calculating means having the positional offset calculating section 121, the correction calculation processing executing section 122, and the three-dimensional shape and surface attribute acquisition calculating section 123 which are shown as functional blocks in the calculation device 12.

Note that the respective configurations of the first embodiment of the present invention can be of course be modified and changed into various ways.

For example, when normal photographing is carried out, depending on the environmental conditions, there is no need to make the built-in flash device 9 emit light.

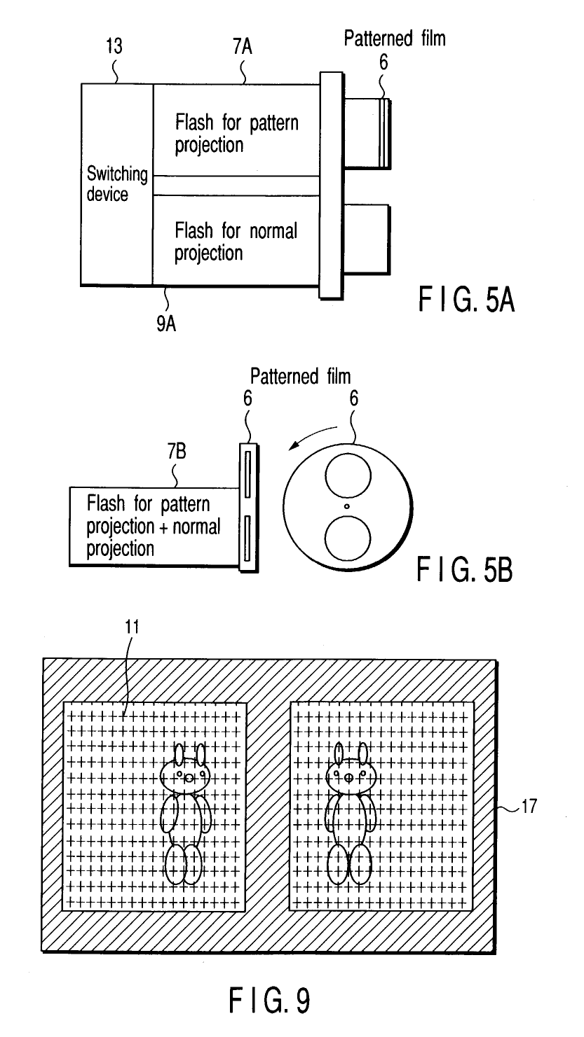

Further, as shown in FIG. 5A, by making a switching device 13 have the function of switching between projection by a flash device 7A for pattern projection by the patterned film 6 and a flash device 9A for normal projection, the flash device 7A for pattern projection and the flash device 9A for normal projection may be substantially united into one flash device.

Furthermore, as shown in FIG. 5B, by making one flash device 7B for projection have a function of switching between pattern projection by the patterned film 6 and normal projection due to the patterned film 6 being made to be freely rotatable, a flash device for pattern projection and a flash device for normal projection may be united into one flash device.

Alternatively, instead of the film 6 having a pattern printed thereon, the pattern may be generated by liquid crystal, and the flash device itself may be replaced with a projecting system other than a flash device such as a liquid crystal projector or the like.

The order of carrying out normal photographing and pattern projection photographing may be the opposite of that in the above-described case.

Further, the order of carrying out acquisition of the surface shape and acquisition of the surface attributes may be the opposite of that in the above-described case.

In addition, oppositely to the above-described case, the offset searching points 11 may be set on the pattern projection image 8, and the positional offset calculating section 121 of the calculation device 12 may be searched that the offset searching points 11 do move to which coordinates on the normally photographed image 10.

When the positional offset calculating section 121 of the calculation device 12 searches that the offset searching points 11 do move to which coordinates on the other image, color information used in the pattern or the like may be ignored, namely, the searching accuracy may be improved by using color information which is not used in the pattern.

Further, when the positional offset calculating section 121 of the calculation device 12 searches that the offset searching points 11 do move to which coordinates on the other image, the searching accuracy may be improved by ignoring the portions on which the pattern is verified.

Moreover, the converting in the direction in which the calculated offset is eliminated by the correction calculation processing executing section 122 of the calculation device 12 may be carried out not on the normally photographed image 10, but on the pattern projection image 8 or on the surface shape and surface attributes calculated based on the offset.

The calculation device 12 may be built-in into the digital camera 5.

Various types of calculation processings by the calculation device 12 may be carried out at the time of photographing, or may be carried out off-line after photographing.

Further, the digital camera 5 does not have to be a still camera, and may be a digital camera for moving image photographing which repeats the pattern projection photographing and the normal photographing.

(Second Embodiment)

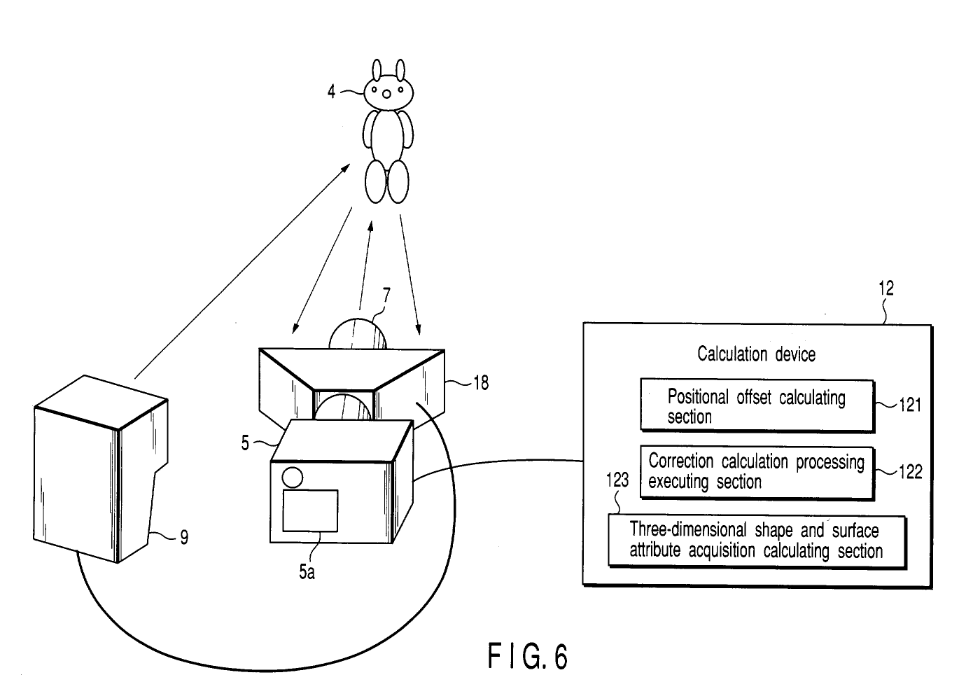

FIG. 6 is a diagram which shows a configuration of a three-dimensional information acquiring device according to a second embodiment of the present invention, and which shows a state in which an object 4 is photographed.

That is, as shown in FIG. 6, the three-dimensional information acquiring device according to the second embodiment of the present invention is configured of a digital camera 5 having a stereo adapter 18 mounted at a front surface portion thereof and serving as a stereo image pick-up system for photographing images from a plurality of standpoints, and an external calculation device 12 such as a personal computer or the like to be connected to the digital camera 5.

Here, the digital camera 5 serving as a stereo image pick-up system has an electronic finder 5a serving as a display device at a back surface portion thereof.

The calculation device 12 such as a personal computer or the like has a positional offset calculating section 121, a correction calculation processing executing section 122, and a three-dimensional shape and surface attribute acquisition calculating section 123 which are shown as functional blocks in the calculation device 12.

Further, a flash device 7 for pattern projection photographing which will be described later is loaded in the stereo adapter 18 mounted as a stereo image pick-up system at the front surface portion of the digital camera 5. An external flash device 9 for normal photographing which will be described later is connected to the stereo adapter 18.

Here, a film 6A, on which a known pattern for pattern projection photographing which will be described later is printed, is loaded at light emitting section of the flash device 7 for pattern projection photographing.

In FIG. 6, reference numeral 4 denotes the object.

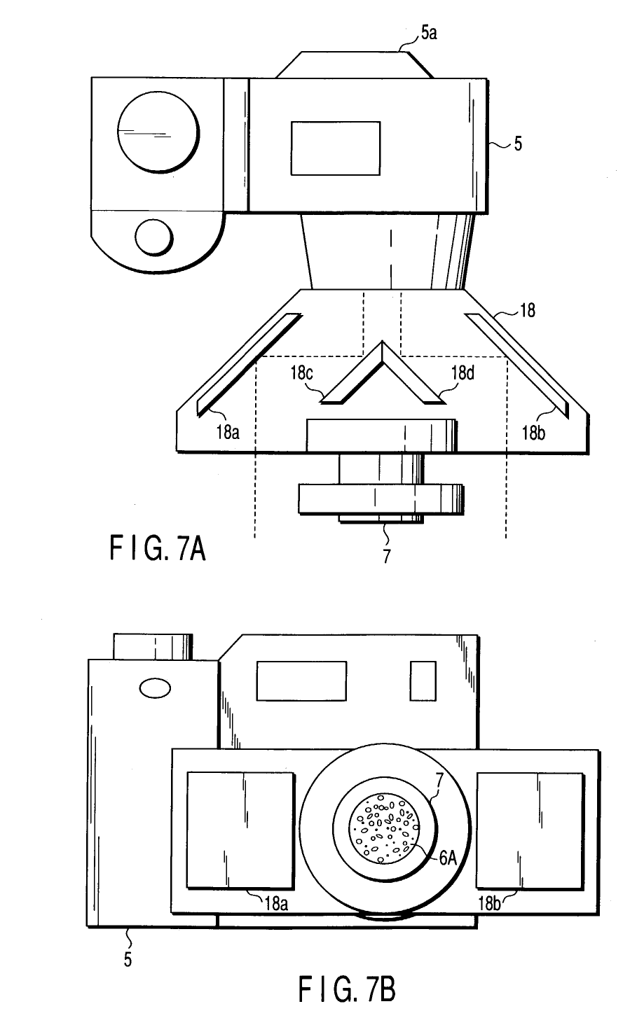

FIGS. 7A and 7B are a plan view and a front view showing configurations of the digital camera 5 as a stereo image-pickup system for use in the three-dimensional information acquiring device according to the second embodiment of the present invention which is configured as shown in FIG. 6, and the stereo adapter 18 mounted at the front surface portion of the digital camera 5.

In other words, the stereo adapter 18 mounted at the front surface portion of the digital camera 5 enables the digital camera 5 to photograph the object 4 as an image from two standpoints via respective pairs of first reflecting mirrors 18a, 18b and second reflecting mirrors 18c, 18d which respectively have predetermined inclined angles and which are disposed so as to face one another.

Further, the flash device 7 for pattern projection photographing which will be described later is loaded at the front surface portion of the stereo adapter 18.

The three-dimensional information acquiring device according to the second embodiment of the present invention is an example in which, in a stereo photographing system for improving the stereo matching accuracy by projecting pattern, offset between a normal photographed stereo image and a pattern projection stereo image is corrected in the same manner as in the first embodiment.

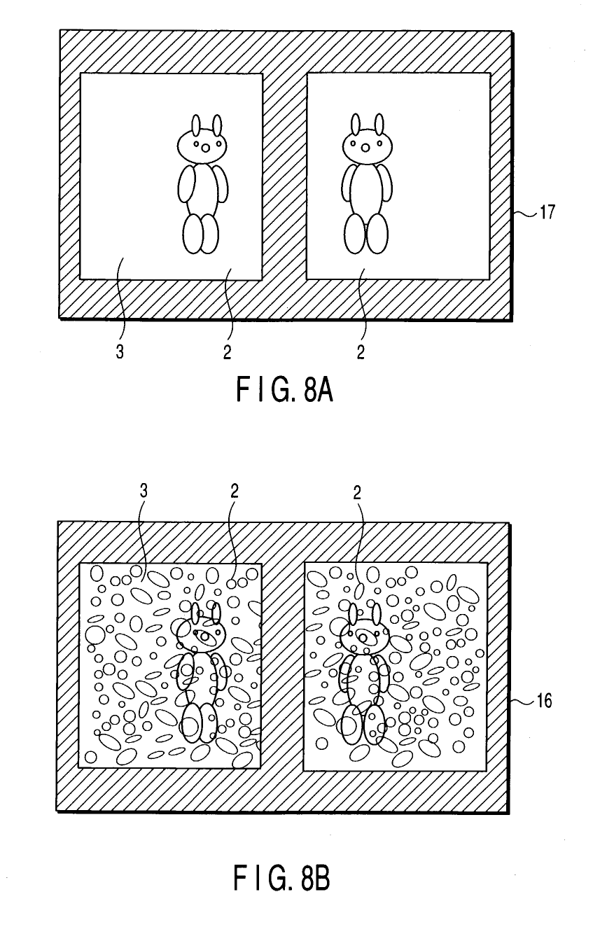

FIG. 8A is a diagram illustrating a normal photographed stereo image 17 obtained by normally photographing by making the external flash device 9 to be connected to the digital camera 5 emit light, when the object 4 is photographed by using the digital camera 5 having the stereo adapter 18 mounted at the front surface portion thereof as a stereo image pick-up system for photographing an image from a plurality of standpoints, and the external calculation device 12, such as a personal computer or the like to be connected to the digital camera 5, as shown in FIG. 6 and FIGS. 7A and 7B, which constitute the three-dimensional information acquiring device according to the second embodiment of the present invention.

Further, FIG. 8B is a diagram illustrating a pattern projection stereo image 16 obtained by carrying out pattern projection photographing by making the flash device 7 for pattern projection photographing, which is loaded at the front surface portion of the stereo adapter 18, emit light when the object 4 is photographed by using the digital camera 5 having the stereo adapter 18 mounted at the front surface portion thereof as a stereo image pick-up system for photographing an image from a plurality of standpoints, and the external calculation device 12 such as a personal computer or the like to be connected to the digital camera 5, as shown in FIG. 6 and FIGS. 7A and 7B, which constitute the three-dimensional information acquiring device according to the second embodiment of the present invention.

FIG. 9 is a diagram illustrating a case in which the plurality of offset searching points 11 are set as offset searching points on the entire normal photographed stereo image 17 in the three-dimensional information acquiring device according to the second embodiment of the present invention.

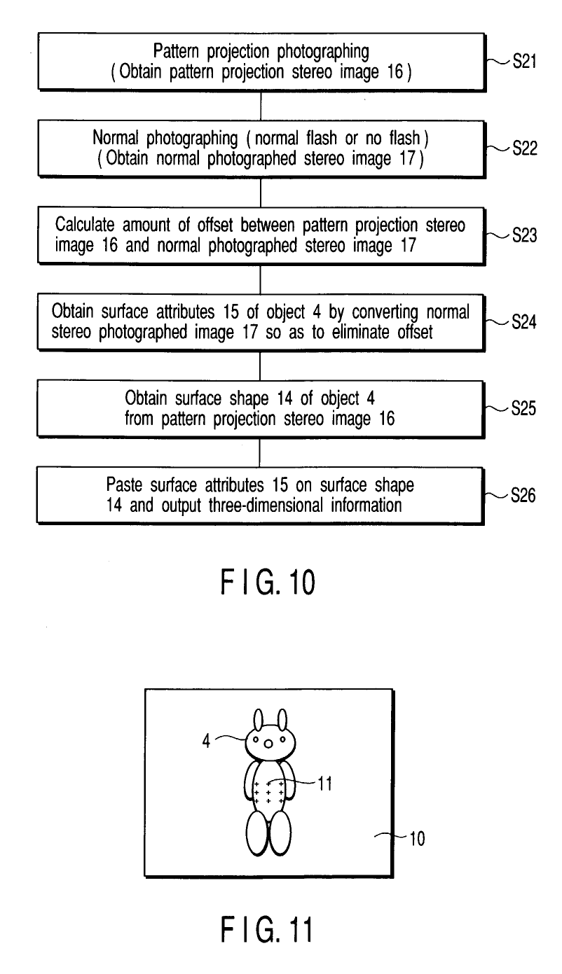

FIG. 10 is a flowchart for explaining the procedures of processing for acquiring three-dimensional information by photographing the object 4 with the digital camera 5 having the stereo adapter 18 mounted at the front surface portion thereof as a stereo image pick-up system for photographing an image from a plurality of standpoints, and the external calculation device 12 such as a personal computer or the like to be connected to the digital camera 5, as shown in FIG. 6 and FIGS. 7A and 7B, which constitute the three-dimensional information acquiring device according to the second embodiment of the present invention.

Next, operations of the three-dimensional information acquiring device according to the second embodiment of the present invention which is configured as shown in FIG. 6 and FIGS. 7A and 7B will be described with reference to FIGS. 8A and 8B to FIG. 10.

Namely, as shown in the flowchart of FIG. 10, in the three-dimensional information acquiring device according to the second embodiment of the present invention, first, the digital camera 5, which has the stereo adapter 18 mounted at the front surface portion thereof as a stereo image pick-up system for photographing an image from a plurality of standpoints, obtains the pattern projection stereo image 16 as shown in FIG. 8B by carrying out pattern projection photographing with respect to the object 4 by making the flash device 7 for pattern projection photographing emit light to the object 4 (step S21).

Secondly, the digital camera 5 obtains the normal photographed stereo image 17 shown in FIG. 8A by carrying out normal photographing with respect to the object 4 by making the external flash device 9, which is connected to the stereo adapter 18, emit light (flash) (step S22).

Next, as shown in FIG. 9, by setting the plurality of offset searching points 11 on the entire normally photographed stereo image 17, the positional offset calculating section 121 of the calculation device 12 searches that the respective offset searching 11 do move to which coordinates on the pattern projection stereo image 16.

Further, the positional offset calculating section 121 of the calculation device 12 statistically processes the coordinate movements of the respective offset searching points 11, and calculates the offset between the normally photographed stereo image 17 and the pattern projection stereo image 16 (parallel and rotary movements) (step S23).

The correction calculation processing executing section 122 of the calculation device 12 then converts the normal photographed stereo image 17 in a direction in which the calculated offset is eliminated.

Further, as shown in FIGS. 8A and 8B, the three-dimensional shape and surface attribute acquisition calculating section 123 of the calculation device 12 obtains a reference image 3 thereamong as the surface attributes of the object 4 (step S24).

Next, the three-dimensional shape and surface attribute acquisition calculating section 123 of the calculation device 12 acquires the surface shape of the object 4 by stereo matching from the pattern projection stereo image 16 as shown in FIG. 8A (step S25).

Then, the three-dimensional shape and surface attribute acquisition calculating section 123 of the calculation device 12 acquires and outputs the three-dimensional information of the object 4 by pasting the surface attributes acquired in the step S24 on the surface shape acquired in the step S25 (step S26).

As described above, the calculation device 12 such as a personal computer or the like first calculates the offset between a position of the object in the pattern projection image and a position of the object in the normal photographed image by the positional offset calculating section 121.

The calculation device 12 executes correction calculation processing by the correction calculation processing executing section 122 on the pattern projection image or the normal photographed image so as to eliminate the calculated offset.

In addition, the calculation device 12 acquires the three-dimensional shape and the surface attributes of the object by the three-dimensional shape and surface attribute acquisition calculating section 123 by utilizing the results of the correction calculation processing and the pattern projection image or the normal photographed image on which the correction calculation processing has not been carried out.

In this way, the calculation device 12 such as a personal computer or the like functions as calculating means having the positional offset calculating section 121, the correction calculation processing executing section 122, and the three-dimensional shape and surface attribute acquisition calculating section 123 which are shown as functional blocks in the calculation device 12.

Note that the respective configurations of the second embodiment of the present invention can of course be modified and changed into various ways.

For example, when normal photographing is carried out, depending on the environmental conditions, there is no need to make the external flash device 9 connected to the stereo adapter 18 emit light.

As shown in FIG. 5A, by making a switching device 13 have the function of switching between projection by a flash device 7A for pattern projection and a flash device 9A for normal projection, the flash device 7A for pattern projection and the flash device 9A for normal projection may be substantially united into one flash device.

Further, as shown in FIG. 5B, by making one flash device 7B for projection have a function of switching between pattern projection by the patterned film 6 and normal projection due to the patterned film 6 being made to be freely rotatable, a flash device for pattern projection and a flash device for normal projection may be united into one flash device.

Alternatively, instead of the film 6 on which a pattern is printed, the pattern may be generated by liquid crystal, and the flash device itself may be replaced with a projecting system other than a flash device such as a liquid crystal projector or the like.

The order of carrying out normal photographing and pattern projection photographing may be the opposite of that in the above-described case.

The order of carrying out acquisition of the surface shape and acquisition of the surface attributes may be the opposite of that in the above-described case.

Further, oppositely to the above-described case, the offset searching points 11 may be set on the patterned light projected stereo image 16, and the positional offset calculating section 121 of the calculation device 12 may be searched that the offset searching points 11 do move to which coordinates on the normally photographed stereo image 17.

When the positional offset calculating section 121 of the calculation device 12 searches that the offset searching points 11 do move to which coordinates on the other image, color information used in the pattern or the like may be ignored, namely, the searching accuracy may be improved by using color information which is not used in the pattern.

In addition, when the positional offset calculating section 121 of the calculation device 12 searches that the offset searching points 11 do move to which coordinates on the other image, the searching accuracy may be improved by ignoring the portions on which the pattern is verified.

The converting in the direction in which the calculated offset is eliminated by the correction calculation processing executing section 122 of the calculation device 12 may be carried out not on the normally photographed stereo image 17, but on the pattern projection stereo image 16 or on the surface shape and surface attributes calculated based on the offset.

The calculation device 12 may be built-in into the digital camera 5.

Various types of calculation processings by the calculation device 12 may be carried out at the time of photographing, or may be carried out off-line after photographing.

Further, the digital camera 5 does not have to be a still camera, and may be a digital camera for moving image photographing which repeats the pattern projection photographing and the normal photographing.

Furthermore, stereo photographing may be carried out by using a plurality of digital cameras 5, and not by mounting the stereo adapter 18 to the digital camera 5.

The pattern to be projected may be either of a random pattern and a known pattern.

In addition, the offset searching points 11 do no have to be set over an entire stereo image 2, and may be set only on the reference image 3.

(Third Embodiment)

A three-dimensional information acquiring device according to a third embodiment of the present invention is an example in which, in the three-dimensional information acquiring device according to the first embodiment described above, the offset searching points are set at the central portion of the image, not on the entire image.

FIG. 11 is a diagram illustrating a case in which a plurality of offset searching points 11 are set at the central portion on a normally photographed image 17 as offset searching points in the three-dimensional information acquiring device according to the third embodiment of the present invention.

Other configurations and processing flows are the same as in the case of the three-dimensional information acquiring device according to the first embodiment described above.

Note that the respective configurations of the third embodiment of the present invention can of course be modified and changed in various ways.

For example, the setting positions of the offset searching points does not have to be at the center of the image, and may be at a focusing point or the like.

Further, shape recognition may be carried out from the pattern projection image 8 before the setting of the offset searching points, and threshold value processing may be carried out with respect to the shape (a calculated distance), and setting of the offset searching points may be carried out at a region at which conditions are satisfied.

Modifications and changes other than the above are the same as in the case of the three-dimensional information acquiring device according to the first embodiment described above.

(Fourth Embodiment)

A three-dimensional information acquiring device according to a fourth embodiment of the present invention is an example in which, in the three-dimensional information acquiring device according to the first embodiment described above, with regard to the extraction of the features of the image, because color components of the pattern to be projected are known, offset is corrected by calculating the corresponding relationship between an image in which edges are extracted by color components other than those and an image in which edges are extracted from the normally photographed image.

Accordingly, the three-dimensional information acquiring device according to the fourth embodiment is same as in that of the first embodiment described above except that an edge extraction processing section (not shown) is provided as a functional block in the calculation device 12 such as a personal computer or the like.

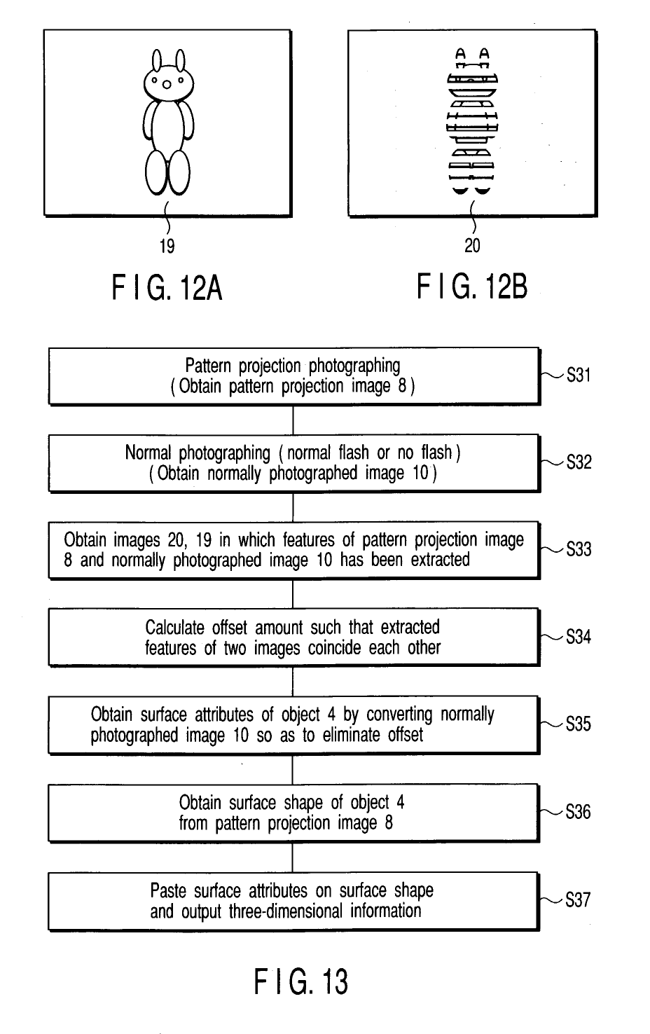

FIG. 12A is a diagram illustrating an image in which edge extraction processing has been carried out on the normally photographed image in the three-dimensional information acquiring device according to the fourth embodiment of the present invention.

FIG. 12B is a diagram illustrating an image in which edge extraction processing has been carried out on color components other than the pattern color components which have been pattern-projected in the three-dimensional information acquiring device according to the fourth embodiment of the present invention.

FIG. 13 is a flowchart for explaining the procedures of processing for acquiring three-dimensional information by photographing the object 4 with the three-dimensional information acquiring device according to the fourth embodiment of the present invention.

Next, operations of the three-dimensional information acquiring device according to the fourth embodiment of the present invention will be described with reference to FIG. 1 to FIGS. 3A, 3B, and FIGS. 12A, 12B and FIG. 13.

In other words, as shown in the flowchart of FIG. 13, in the three-dimensional information acquiring device according to the fourth embodiment of the present invention, first, by carrying out pattern projection photographing with respect to the object 4 by making the external flash device 7, in which the film 6 having a known pattern printed thereon is loaded at the light-emitting section, emit light by the digital camera 5 as shown in FIGS. 1 and 2, the pattern projection image 8 as shown in FIG. 3B is obtained (step S31).

Secondly, by carrying out normal photographing with respect to the object 4 by making the built-in flash device 9 emit light by the digital camera 5, the normally photographed image 10 shown in FIG. 3A is obtained (step S32).

Next, the calculation device 12 obtains an image 19 by carrying out edge extraction with respect to the normally photographed image 10 as shown in FIG. 12A, by the edge extraction processing section (not shown), and obtains an image 20 by carrying out edge extraction processing with respect to the color components other than the projected pattern color components for the pattern projection image 8 as shown in FIG. 12B (step S33).

Subsequently, the positional offset calculating section 121 of the calculation device 12 recognizes which edge on the image 19 obtained in the step S33 does the edge of the image 20 obtained in the step S33 correspond to, and calculates the offset between the normally photographed image 10 and the pattern projection image 8 (parallel and rotary movements) (step S34).

The correction calculation processing executing section 122 of the calculation device 12 then converts the normally photographed image 10 in a direction in which the calculated offset is eliminated.

Further, the three-dimensional shape and surface attribute acquisition calculating section 123 of the calculation device 12 obtains the normally photographed image 10 converted in the direction in which the calculated offset is eliminated, as the surface attributes of the object 4 by the correction calculation processing executing section 122 (step S35).

Next, the three-dimensional shape and surface attribute acquisition calculating section 123 of the calculation device 12 obtains the surface shape of the object 4 from the information of how the known pattern is transformed and photographed on the pattern projection image 8 (step S36).

Then, the three-dimensional shape and surface attribute acquisition calculating section 123 of the calculation device 12 acquires and outputs the three-dimensional information of the object 4 by pasting the surface attributes obtained in the step S35 on the surface shape obtained in the step S36 (step S37).

As described above, the calculation device 12 such as a personal computer or the like calculates the offset between the position of the object in the pattern projection image and the position of the object in the normally photographed image by the positional offset calculating section 121.

Further, the calculation device 12 executes correction calculation processing on the pattern projection image or the normally photographed image so as to eliminate the calculated offset by the correction calculation processing executing section 122.

Furthermore, the calculation device 12 acquires the three-dimensional shape and the surface attributes of the object by the three-dimensional shape and surface attribute acquisition calculating section 123 by utilizing the results of the correction calculation processing and the pattern projection image or the normally photographed image on which the correction calculation processing has not been carried out.

In this way, the calculation device 12 such as a personal computer or the like functions as calculating means having the positional offset calculating section 121, the correction calculation processing executing section 122, and the three-dimensional shape and surface attribute acquisition calculating section 123 which are shown as functional blocks in the calculation device 12.

Note that the respective configurations of the fourth embodiment of the present invention can of course be modified and changed in various ways.

For example, with regard to the feature extraction of the images, edge extraction is one example, but another feature may be extracted if it is a feature which enables correspondence between the pattern projection image 8 and the normally photographed image 10.

Modifications and changes other than these are the same as in the case of the three-dimensional information acquiring device according to the first embodiment described above.

(Fifth Embodiment)

A three-dimensional information acquiring device according to a fifth embodiment of the present invention is an example in which, in the three-dimensional information acquiring device according to the first embodiment described above, a user inputs points at which the pattern projection image and the normally photographed image correspond to one another so that offset is corrected.

The configurations other than this are the same as in the case of the three-dimensional information acquiring device according to the first embodiment described above.

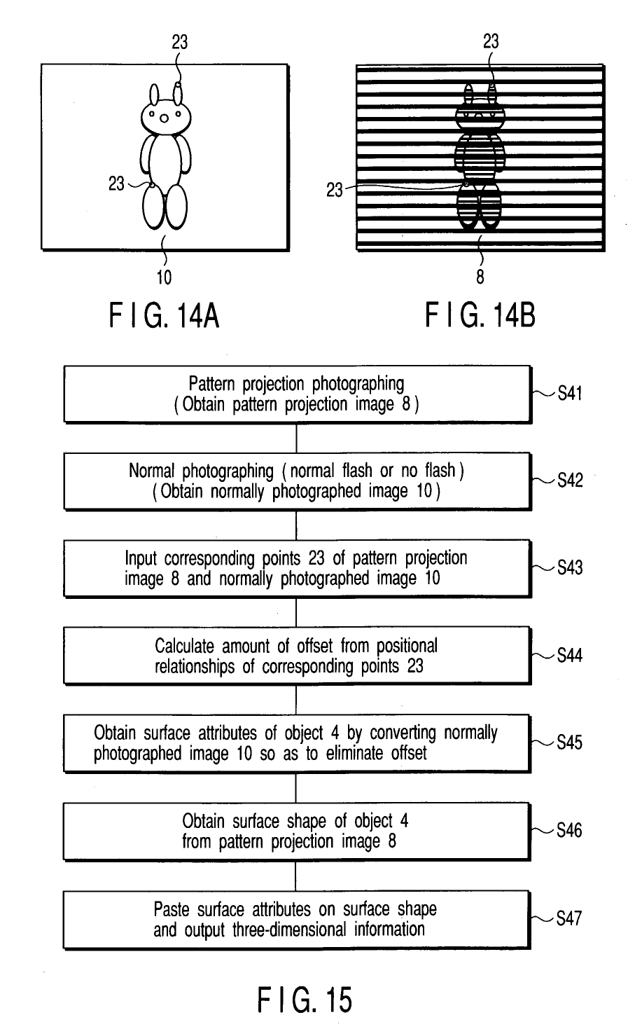

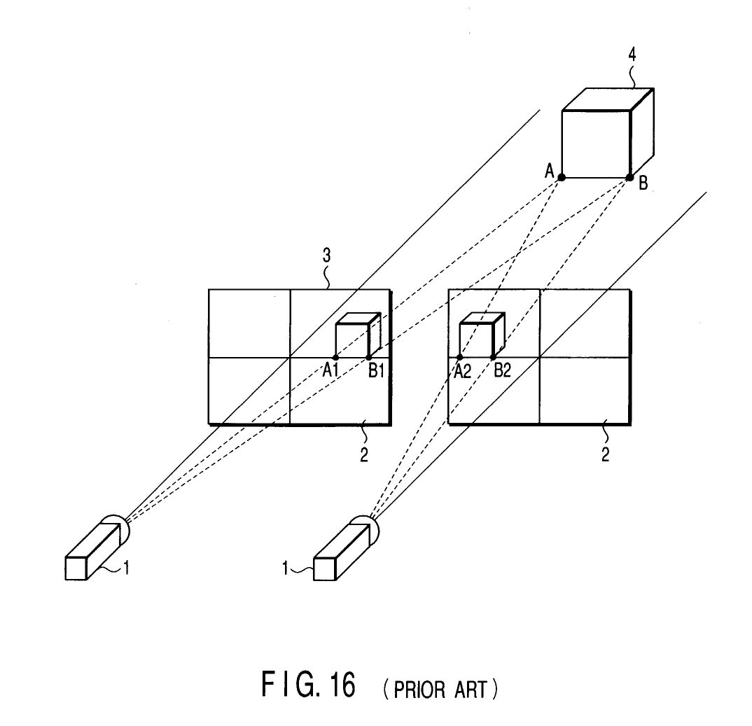

FIG. 14A is a diagram illustrating corresponding points of the normally photographed image which a user inputs in the three-dimensional information acquiring device according to the fifth embodiment of the present invention.

FIG. 14B is a diagram illustrating corresponding points of the patterned light projected image which the user inputs in the three-dimensional information acquiring device according to the fifth embodiment of the present invention.

FIG. 15 is a flowchart for explaining the procedures of processing for acquiring three-dimensional information by photographing the object 4 with the three-dimensional information acquiring device according to the fifth embodiment of the present invention.

Next, operations of the three-dimensional information acquiring device according to the fifth embodiment of the present invention will be described with reference to FIG. 1 through FIGS. 3A, 3B, and FIGS. 14A, 14B and FIG. 15.

Namely, as shown in the flowchart of FIG. 15, in the three-dimensional information acquiring device according to the fifth embodiment of the present invention, first, by carrying out pattern projection photographing with respect to the object 4 by making the external flash device 7, in which the film 6 having a well known pattern printed thereon is loaded at the light-emitting section, emit light by the digital camera 5 as shown in FIGS. 1 and 2, the pattern projection image 8 as shown in FIG. 3B is obtained (step S41).

Secondly, by carrying out normal photographing with respect to the object 4 by making the built-in flash device 9 emit light by the digital camera 5, the normally photographed image 10 as shown in FIG. 3A is obtained (step S42).

Next, the user looks at the pattern projection image 8 and the normally photographed image 10 displayed on the electronic finder Sa serving as a display device, and inputs two points corresponding to one another to set corresponding points 23 (step S43).

In this case, the user inputs the corresponding points 23 of the pattern projection image 8 as shown in FIG. 14B, and inputs the corresponding points 23 of the normally photographed image 10 as shown in FIG. 14A, by means of input keys or the like of the calculation device 12.

Subsequently, the positional offset calculating section 121 of the calculation device 12 calculates the offset (parallel and rotary movements) between the normally photographed image 10 and the pattern projection image 8 from the corresponding points 23 inputted by the user (step S44).

The correction calculation processing executing section 122 of the calculation device 12 then converts the normally photographed image 10 in a direction in which the calculated offset is eliminated.

Further, the three-dimensional shape and surface attribute acquisition calculating section 123 of the calculation device 12 obtains the normally photographed image 10 converted in the direction in which the calculated offset is eliminated, as the surface attributes of the object 4 by the correction calculation processing executing section 122 (step S45).

Next, the three-dimensional shape and surface attribute acquisition calculating section 123 of the calculation device 12 obtains the surface shape of the object 4 from the information of how the known pattern is transformed and photographed on the pattern projection image 8 (step S46).

Then, the three-dimensional shape and surface attribute acquisition calculating section 123 of the calculation device 12 acquires and outputs the three-dimensional information of the object 4 by pasting the surface attribute obtained in the step S45 on the surface shape obtained in the step S46 (step S47).

As described above, the calculation device 12 such as a personal computer or the like first calculates the offset between the position of the object in the pattern projection image and the position of the object in the normally photographed image, by the positional offset calculating section 121.

The calculation device 12 executes correction calculation processing on the pattern projection image or the normally photographed image so as to eliminate the offset calculated described as above, by the correction calculation processing executing section 122.

Further, the calculation device 12 acquires the three-dimensional shape and the surface attributes of the object, by the three-dimensional shape and surface attribute acquisition calculating section 123, by utilizing the results of the correction calculation processing and the pattern projection image or the normally photographed image on which the correction calculation processing has not been carried out.

In this way, the calculation device 12 such as a personal computer or the like functions as calculating means having the positional offset calculating section 121, the correction calculation processing executing section 122, and the three-dimensional shape and surface attribute acquisition calculating section 123 which are shown as functional blocks in the calculation device 12.

Note that the respective configurations of the fifth embodiment of the present invention can of course be modified and changed in various ways.

For example, with regard to the number of the corresponding points 23 which the user inputs, when it is assumed that the offset is only in one direction, one corresponding point 23 may be inputted, and otherwise, two or more corresponding points 23 may be inputted.

Modifications and changes other than those are the same as in the case of the three-dimensional information acquiring device according to the first embodiment described above.

Accordingly, as described above, in accordance with the present invention, a three-dimensional information acquiring system including a three-dimensional information acquiring device and a three-dimensional information acquiring method can be provided in which positional offset of an object in a pattern projection image and a normally photographed image is detected and corrected, and accurate three-dimensional information is acquired, so that the accuracy of pasting the surface attributes on the shape information on the object can be improved, and correct reconstruction of a three-dimensional image can be carried out.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A three-dimensional information acquiring device which obtains a pattern projection image, in which an object is photographed with projecting a predetermined pattern on the object, and a normally photographed image, in which the object is photographed without projecting the pattern before or after the photographing of the pattern projection image, and which acquires a three-dimensional shape and surface attributes of the object based on the pattern projection image and the normally photographed image, the three-dimensional information acquiring device comprising:
a positional offset calculating section which calculates offset between a position of the object in the pattern projection image and a position of the object in the normally photographed image;
a correction calculation processing executing section which executes correction calculation processing on the pattern projection image or the normally photographed image so as to eliminate the offset between the positions of the object calculated by the positional offset calculating section; and
a three-dimensional shape and surface attribute acquisition calculating section which acquires the three-dimensional shape and the surface attributes of the object by utilizing results of the correction calculation processing by the correction calculation processing executing section and the pattern projection image or the normally photographed image on which the correction calculation processing has not been carried out.

2. A three-dimensional information acquiring device according to claim 1, wherein, when the positional offset calculating section calculates the offset between the position of the object in the pattern projection image and the position of the object in the normally photographed image, the positional offset calculating section sets offset searching points on one image of the pattern projection image and the normally photographed image and searches for corresponding points on the other image which correspond to the offset searching points, and specifies positions of the corresponding points and calculates the offset of the object based on differences between the offset searching points and the corresponding points.

3. A three-dimensional information acquiring device according to claim 2, wherein, when the positional offset calculating section sets the offset searching points on one image of the pattern projection image and the normally photographed image, the positional offset calculating section sets a plurality of points, which are set in a specific region of a part of the pattern projection image or the normally photographed image, as the offset searching points.

4. A three-dimensional information acquiring device according to claim 3, wherein, when the positional offset calculating section sets the offset searching points on one image of the pattern projection image and the normally photographed image, the positional offset calculating section sets a plurality of points, which are set based on features of the pattern projection image or the normally photographed image, as the offset searching points.

5. A three-dimensional information acquiring device according to claim 3, wherein, when the positional offset calculating section sets the offset searching points on one image of the pattern projection image and the normally photographed image, the positional offset calculating section sets a plurality of points, which are selected by an operator on the pattern projection image or the normally photographed image, as the offset searching points.

6. A three-dimensional information acquiring system for acquiring a three-dimensional shape and surface attributes of an object, comprising:
an image photographing section which obtains a pattern projection image, in which the object is photographed with projecting a predetermined pattern on the object, and obtains a normally photographed image, in which the object is photographed without projecting the pattern before or after the obtaining of the pattern projection image; and
a three-dimensional information acquiring section which acquires the three-dimensional shape and the surface attributes of the object based on the pattern projection image and the normally photographed image obtained by the image photographing section, the three-dimensional information acquiring section comprising:
a positional offset calculating section which calculates offset between a position of the object in the pattern projection image and a position of the object in the normally photographed image;
a correction calculation processing executing section which executes correction calculation processing on the pattern projection image or the normally photographed image so as to eliminate the offset between the positions of the object calculated by the positional offset calculating section; and
a three-dimensional shape and surface attribute acquisition calculating section which acquires the three-dimensional shape and the surface attributes of the object by utilizing results of the correction calculation processing by the correction calculation processing executing section and the pattern projection image or the normally photographed image on which the correction calculation processing has not been carried out.

7. A three-dimensional information acquiring system according to claim 6, wherein, when the positional offset calculating section calculates the offset between the position of the object in the pattern projection image and the position of the object in the normally photographed image, the positional offset calculating section sets offset searching points on one image of the pattern projection image and the normally photographed image and searches for corresponding points on the other image which correspond to the offset searching points, and specifies positions of the corresponding points and calculates the offset of the object based on differences between the offset searching points and the corresponding points.

8. A three-dimensional information acquiring system according to claim 7, wherein, when the positional offset calculating section sets the offset searching points on one image of the pattern projection image and the normally photographed image, the positional offset calculating section sets a plurality of points, which are set in a specific region of a part of the pattern projection image or the normally photographed image, as the offset searching points.

9. A three-dimensional information acquiring system according to claim 8, wherein, when the positional offset calculating section sets the offset searching points on one image of the pattern projection image and the normally photographed image, the positional offset calculating section sets a plurality of points, which are set based on features of the pattern projection image or the normally photographed image, as the offset searching points.

10. A three-dimensional information acquiring system according to claim 8, wherein, when the positional offset calculating section sets the offset searching points on one image of the pattern projection image and the normally photographed image, the positional offset calculating section sets a plurality of points, which are selected by an operator on the pattern projection image or the normally photographed image, as the offset searching points.

11. A three-dimensional information acquiring method for obtaining a pattern projection image, in which an object is photographed with projecting a predetermined pattern on the object, and a normally photographed image, in which the object is photographed without projecting the pattern before or after the photographing of the pattern projection image, and for acquiring a three-dimensional shape and surface attributes of the object based on the pattern projection image and the normally photographed image, the three-dimensional information acquiring method comprising:
calculating offset between a position of the object in the pattern projection image and a position of the object in the normally photographed image;
executing correction calculation processing on the pattern projection image or the normally photographed image so as to eliminate the offset between the calculated positions of the object; and
acquiring the three-dimensional shape and the surface attributes of the object by utilizing the results of the correction calculation processing and the pattern projection image or the normally photographed image on which the correction calculation processing has not been carried out.

12. A three-dimensional information acquiring method according to claim 11, wherein, when offset between the position of the object in the pattern projection image and the position of the object in the normally photographed image is calculated, offset searching points are set on one image of the pattern projection image and the normally photographed image, and corresponding points on the other image which correspond to the offset searching points are searched for, and positions of the corresponding points are specified, and the offset of the object is calculated based on differences between the offset searching points and the corresponding points.

13. A three-dimensional information acquiring method according to claim 12, wherein, when the offset searching points are set on one image of the pattern projection image and the normally photographed image, a plurality of points, which are set in a specific region of a part of the pattern projection image or the normally photographed image, are set as the offset searching points.

14. A three-dimensional information acquiring method according to claim 13, wherein, when the offset searching points are set on one image of the pattern projection image and the normally photographed image, a plurality of points, which are set based on features of the pattern projection image or the normally photographed image, are set as the offset searching points.

15. A three-dimensional information acquiring method according to claim 13, wherein, when the offset searching points are set on one image of the pattern projection image and the normally photographed image, a plurality of points, which are selected by an operator on the pattern projection image or the normally photographed image, are set as the offset searching points.

16. A three-dimensional information acquiring device for obtaining a pattern projection image, in which an object is photographed with projecting a predetermined pattern on the object, and a normally photographed image, in which the object is photographed without projecting the pattern before or after the photographing of the pattern projection image, and for acquiring three-dimensional shape and surface attributes of the object based on the pattern projection image and the normally photographed image, the three-dimensional information acquiring device comprising:
positional offset calculating means for calculating offset between a position of the object in the pattern projection image and a position of the object in the normally photographed image;
correction calculation processing executing means for executing correction calculation processing on the pattern projection image or the normally photographed image so as to eliminate the offset between the positions of the object calculated by the positional offset calculating means; and
three-dimensional shape and surface attribute acquisition calculating means for acquiring the three-dimensional shape and the surface attributes of the object by utilizing results of the correction calculation processing by the correction calculation processing executing means and the pattern projection image or the normally photographed image on which the correction calculation processing has not been carried out.

17. A three-dimensional information acquiring device according to claim 16, wherein, when the positional offset calculating means calculates the offset between the position of the object in the pattern projection image and the position of the object in the normally photographed image, the positional offset calculating means sets offset searching points on one image of the pattern projection image and the normally photographed image and searches for corresponding points on the other image which correspond to the offset searching points, and specifies positions of the corresponding points and calculates the offset of the object based on differences between the offset searching points and the corresponding points.

18. A three-dimensional information acquiring device according to claim 17, wherein, when the positional offset calculating means sets the offset searching points on one image of the pattern projection image and the normally photographed image, the positional offset calculating means sets a plurality of points, which are set in a specific region of a part of the pattern projection image or the normally photographed image, as the offset searching points.

19. A three-dimensional information acquiring device according to claim 18, wherein, when the positional offset calculating means sets the offset searching points on one image of the pattern projection image and the normally photographed image, the positional offset calculating means sets a plurality of points, which are set based on features of the pattern projection image or the normally photographed image, as the offset searching points.

20. A three-dimensional information acquiring device according to claim 18, wherein, when the positional offset calculating means sets the offset searching points on one image of the pattern projection image and the normally photographed image, the positional offset calculating means sets a plurality of points, which are selected by an operator on the pattern projection image or the normally photographed image, as the offset searching points.

21. A three-dimensional information acquiring system for acquiring a three-dimensional shape and surface attributes of an object, comprising:
image photographing means for obtaining a pattern projection image, in which an object is photographed with projecting a predetermined pattern on the object, and for obtaining a normally photographed image, in which the object is photographed without projecting the pattern before or after the obtaining of the pattern projection image; and
three-dimensional information acquiring means for acquiring the three-dimensional shape and the surface attributes of the object based on the pattern projection and the normally photographed image obtained by the image photographing means, the three-dimensional information acquiring means comprising:
positional offset calculating means for calculating offset between a position of the object in the pattern projection image and a position of the object in the normally photographed image;
correction calculation processing executing means for executing correction calculation processing on the pattern projection image or the normally photographed image so as to eliminate the offset between the positions of the object calculated by the positional offset calculating means; and
three-dimensional shape and surface attribute acquisition calculating means for acquiring the three-dimensional shape and the surface attributes of the object by utilizing results of the correction calculation processing by the correction calculation processing executing means and the pattern projection image or the normally photographed image on which the correction calculation processing has not been carried out.

22. A three-dimensional information acquiring system according to claim 21, wherein, when the positional offset calculating means calculates the offset between the position of the object in the pattern projection image and the position of the object in the normally photographed image, the positional offset calculating means sets offset searching points on one image of the pattern projection image and the normally photographed image and searches for corresponding points on the other image which correspond to the offset searching points, and specifies positions of the corresponding points and calculates the offset of the object based on differences between the offset searching points and the corresponding points.

23. A three-dimensional information acquiring system according to claim 22, wherein, when the positional offset calculating means sets the offset searching points on one image of the pattern projection image and the normally photographed image, the positional offset calculating means sets a plurality of points, which are set in a specific region of a part of the pattern projection image or the normally photographed image, as the offset searching points.

24. A three-dimensional information acquiring system according to claim 23, wherein, when the positional offset calculating means sets the offset searching points on one image of the pattern projection image and the normally photographed image, the positional offset calculating means sets a plurality of points, which are set based on features of the pattern projection image or the normally photographed image, as the offset searching points.

25. A three-dimensional information acquiring system according to claim 23, wherein, when the positional offset calculating means sets the offset searching points are set on one image of the pattern projection image and the normally photographed image, the positional offset calculating means sets a plurality of points, which are selected by an operator on the pattern projection image or the normally photographed image, as the offset searching points.

26. A three-dimensional information acquiring method for acquiring a three-dimensional shape and surface attributes of an object, comprising:
acquiring a pattern projection image, in which the object is photographed with projecting a predetermined pattern on the object, and acquiring a normally photographed image, in which the object is photographed without projecting the pattern before or after the obtaining of the pattern projection image; and
acquiring the three-dimensional shape and the surface attributes of the object based on the pattern projection image and the normally photographed image, the acquiring of the three-dimensional shape and the surface attributes of the object comprising:
calculating offset between a position of the object in the pattern projection image and a position of the object in the normally photographed image;
executing correction calculation processing on the pattern projection image or the normally photographed image so as to eliminate the offset between the positions of the object; and
acquiring the three-dimensional shape and the surface attributes of the object by utilizing results of the correction calculation processing and the pattern projection image or the normally photographed image on which the correction calculation processing has not been carried out.

27. A three-dimensional information acquiring method according to claim 26, wherein, when the offset between the position of the object in the pattern projection image and the position of the object in the normally photographed image is calculated, offset searching points are set on one image of the pattern projection image and the normally photographed image, and corresponding points on the other image which correspond to the offset searching points are searched for, and positions of the corresponding points are specified, and the offset of the object is calculated based on differences between the offset searching points and the corresponding points.

28. A three-dimensional information acquiring method according to claim 27, wherein, when the offset searching points are set on one image of the pattern projection image and the normally photographed image, a plurality of points, which are set in a specific region of a part of the pattern projection image or the normally photographed image, are set as the offset searching points.

29. A three-dimensional information acquiring method according to claim 28, wherein, when the offset searching points are set on one image of the pattern projection image and the normally photographed image, a plurality of points, which are set based on features of the pattern projection image or the normally photographed image, are set as the offset searching points.

30. A three-dimensional information acquiring method according to claim 28, wherein, when the offset searching points are set on one image of the pattern projection image and the normally photographed image, a plurality of points, which are selected by an operator on the pattern projection image or the normally photographed image, are set as the offset searching points.
